(19) United States
(12) Patent Application Publication
(10) Pub. No.: US 2007/0240495 A1
(43) Pub. Date: Oct. 18, 2007

(54) Microfluidic Device and Analyzing/Sorting Apparatus Using The Same

(76) Inventor: Shuzo Hirahara, Kanagawa (JP)

Correspondence Address: BANNER & WITCOFF, LTD., 1100 13th STREET, N.W., SUITE 1200, WASHINGTON, DC, 20005-4051, US

(21) Appl. No.: 11/597,479

(22) PCT Filed: May 24, 2005
(86) PCT No.: PCT/JP05/09402

§ 371 Date: Nov. 22, 2006

(30) Foreign Application Priority Data
May 25, 2004 (JP) 2004-154310
Jun. 16, 2004 (JP) 2004-178129
Jul. 30, 2004 (JP) 2004-222761

(51) Int. Cl. B01J 19/08; B01L 11/00

(52) U.S. Cl. 73/53.01; 204/643

(57) ABSTRACT

A microfluidic device of an example of the present invention having a main flow channel for allowing a fluid including carrier liquid and a specimen to flow and analyzing or sorting out the specimen typically comprises a plurality of electrodes arranged around a part of the main flow channel and adapted to be subjected to a voltage applied thereto in order to cause dielectrophoretic force to act on the specimen passing through it.

### TECHNICAL FIELD

This invention relates to a microfluidic device for cutting a micrometer-sized flow channel in a glass or plastic substrate and handling a very small quantity of specimen. More particularly, the present invention relates to a microfluidic device and an analyzing/sorting apparatus for analyzing a specific ingredient of a specimen where biological materials such as genes, proteins, viruses, cells and bacteria and micro substances coexist and/or sorting out the specific ingredient.

### BACKGROUND ART

Gas chromatography, liquid chromatography and mass spectrometry are known as techniques for highly accurately analyzing and sorting out specimens. However, in apparatus designed to use any of such techniques, the specimen is exposed to heat/gasification, discharge ionization, an intense electric field, a high voltage, a large electric current, vacuum, strong shearing force, chemical modification or a chemical input. Therefore, if the specimen is a biological material such as a gene, a protein or a cell, it is difficult to recover the specimen to the original condition after the analysis due to thermal decomposition or electric, mechanical or chemical damage.

Techniques such as fluorescent labeling of adding a fluorescent dye, a fluorescent protein or a quantum dot and labeling by means of a known substance that can easily and selectively be coupled with a target are employed to detect nanometer-sized substances. However, such techniques are accompanied by a problem that they cannot prevent not only damages due to exposure to high energy light such as excited rays of light and fluorescence but also conformational changes and degenerations due to the labeling substance coupled to the specimen. Leucocytes and thrombocytes that are micrometer-sized biological materials have a problem that the aggregation activity thereof can be activated and they are apt to be deformed in an unusual environment or in the presence of an unnatural substance.

Microfluidic devices have become popular in recent years because of the advantages they have in terms of a higher analyzing speed, a reduction of the required quantity of specimen and downsizing and, above all, electrophoretic chromatography that can realize a relatively high degree of precision with a simple arrangement and electroosmotic flow chromatography derived from electrophoretic chromatography are in the mainstream. However, such techniques are accompanied by a problem of a poor accuracy level of measurement due to a short separation distance and a low precision level of the profile of the flow channel if compared with conventional electrophoretic chromatography using glass capillaries.

Additional problems to be dissolved include, among others, that it is more difficult to remove the substances adhering to the inner wall surface of a micronized capillary and that the ratio of the wasted specimen is not reduced even if the filling quantity of the specimen is reduced as a result of micronization (dead volume problem).

Furthermore, in the case of electrophoretic chromatography, the maximum diameter of particles that can be separated with a high degree of accuracy is about 15 nm (about 1 M daltons in terms of molecular weight). With ordinary liquid chromatography that can be used to analyze large molecules, it is difficult to separate the substance to be observed when the size thereof exceeds 30 nm (about 10 M daltons in terms of molecular weight). However, there are many huge macromolecular substances whose molecular weight exceeds 1 M daltons as far as biological materials such as proteins are concerned. Thus, there is a demand for techniques and apparatus that can accurately analyze specimens having a large molecular weight, if the quantity of the specimen is small.

On the other hand, research efforts are being made to introduce new separation techniques by effectively exploiting the specific properties that become available when the specimen has a so-called macro size or sub-macro size besides the known techniques for utilizing the advantages of downsizing. Examples of such techniques include those that cause dielectrophoretic force to act as described in Patent Document 1, Patent Document 2, Patent Document 3, Non-Patent Document 1, Non-Patent Document 2, Non-Patent Document 3, Non-Patent Document 4 and Non-Patent Document 5 and those that arrange a pillar-shaped obstacle structure in the flow channel as described in Patent Document 4 and Patent Document 5. Techniques of arranging an obstacle in the flow channel and causing dielectrophoretic force to act as described in Non-Patent Document 6 and Patent Document 6 are also proposed.

Patent Document 1 proposes a gas chromatography technique of applying an alternating voltage with a frequency between 100 Hz and 100 MHz to a comb-shaped electrode arranged on the bottom of a flow channel to cause dielectrophoretic force to be applied to the specimen flowing in the flow channel and observing the time that the specimen takes to pass through the flow channel. While this technique is accompanied by a problem of improving the accuracy level but no report has been made to date about the subsequent technological development, if any.

Patent Document 2 proposes a technique of separating a specimen by using a flow channel showing a longitudinally long cross section and utilizing the balance or the difference of gravity and dielectrophoretic force. However, the proposed technique shows a poor separation accuracy level and can be applied to only a particle larger than micrometers that gravity can act.

Non-Patent Document 1 presents a theory for obtaining information on the electric properties (dielectric constant and electric conductivity) and the structure (cell membrane and cell size, eccentricity ratio) of a specimen such as a cell by dielectrophoresis. According to the dielectrophoresis theory, it is possible to know not only the electric properties of the specimen but also the rough internal structure (existence or non-existence of a membrane structure) of the specimen from the frequency spectrum pattern thereof. Non-Patent Document 2 shows that it is possible to analyze not only the profile of a spherical substance but also a chain-shaped molecule such as a DNA by handling it as an ellipsoid of revolution.

The following proposal is also made on the basis of the dielectrophoresis theory. According to Non-Patent Document 3, the salt concentration of liquid is defined as variable and the complex dielectric constant of the cell membrane and that of the inside of the cell (expressed by ε+σ/jω, where ε is the dielectric constant, σ is the electric conductivity, j is the imaginary unit and ω is the angular frequency) are obtained from the characteristic of the frequency that inverts the sign of dielectrophoresis from positive to negative and vice versa (and switches the sign of the Clausius-Mossoty coefficient).

Non-Patent Document 4 describes an experiment for trapping specimens flowing on a flat through flow in the transversal cross-sectional direction in a liquid tank by means of a pillar-shaped quadropole electrode. However, in addition to the difficulty of controlling the flow and the voltage, many specimens slip away to become wasted because the ratio of the area of the trap to that of the cross section of the flow is theoretically small and the force for trapping specimens is weak. Both the technique of Non-Patent Document 3 and that of Non-Patent Document 4 have problems to be solved such as how to save specimens, how to improve the accuracy of measurement and observation and how to automate the process.

Non-Patent Document 5 is based on the concept of using four process elements (funnel, aligner, cage, switch) in order to measure the electric characteristics of a specimen. However, with the described technique, the electric characteristics are measured on condition that the specimen is still and visual judgment is required in certain occasions. Thus, the technique lacks reliability and is accompanied by a problem of automation.

Patent Document 3 describes an experiment of converging specimens to the center of a cylindrical micro flow channel along which annular electrodes are arranged in series. However, with this structure, it is not possible to draw out various performances of dielectrophoresis other than convergence.

On the other hand, Patent Document 4 and Patent Document 5 propose techniques of realizing an improved separation capability not by using a conventional filling material such as gel but by using a structure formed by setting up nanometer-sized pillars (nano-pillars). However, the proposed techniques involve contingency and unevenness to a large extent that arise from the interaction of the pillars that shows a fixed phase and the specimens and a large width of dispersion of spectrum (chromatogram) so that they cannot be used for separation and analysis if a high degree of accuracy is required.

Non-Patent Document 6 describes the use of a combination of a micrometer-sized tableland-like structure (micro-post) arranged in a flow channel and dielectrophoresis while Patent Document 6 describes the use of a combination of beads filled in a flow channel and dielectrophoresis in order to filter specimens such as microbes by utilizing an obstacle and dielectrophoretic force. The documents also describe experiments where specimens are sorted into two types by means of a predefined threshold value. However, the likelihood of success of the operation is low and it is difficult to use either of the techniques for the purpose of measurements.
Patent Document 1: Jpn. Pat. Appln. Laid-Open Publication No. 5-126796
Patent Document 2: PCT Pat. Appln. Laid-Open Publication No. 2003-507739
Patent Document 3: WO 2004/074814 (PCT/US2004/004783)
Patent Document 4: Jpn. Pat. Appln. Laid-Open Publication No. 2004-156926
Patent Document 5: Jpn. Pat. Appln. Laid-Open Publication No. 2004-45357
Patent Document 6: Jpn. Pat. Appln. Laid-Open Publication No. 2003-200081
Patent Document 7: PCT Pat. Appln. Laid-Open Publication No. 10-507516
Patent Document 8: Jpn. Pat. Appln. Laid-Open Publication No. 2000-356611
Patent Document 9: Jpn. Pat. Appln. Laid-Open Publication No. 2000-356746
Non-Patent Document 1: K. V. I. S. Kaler and T. B. Jones: “Dielectrophoretic spectra of single cells determined by feedback-controlled levitation”, Biophysical Journal, vol. 57, pp. 173-182 (1990).
Non-Patent Document 2: Lifeng Zheng, James P. Brody, and Peter J. Burke: “Electronic Manipulation of DNA, Proteins, and Nanoparticles for Potential Circuit Assembly”, Biosensors & Bioelectronics, vol. 20, no. 3, pp. 606-619 (2004).
Non-Patent Document 3: M. P. Hughes, H. Morgan, and F. J. Rixon: “Measuring the dielectric properties of herpes simplex virus type 1 virions with dielectrophoresis”, Biochimica et Biophysica Acta, 1571, pp. 1-8 (2002).
Non-Patent Document 4: J. Voldman, M. L. Gray, M. Toner, and M. A. Schmidt: “A Microfabrication-Based Dynamic Array Cytometer”, Analytical Chemistry, vol. 74, no. 16, pp. 3984-3990 (2002).
Non-Patent Document 5: T. Muller, G. Gradl, S. Howitz, S. Shirley, Th. Schnelle, and G. Fuhr; “A 3-D microelectrode system for handling and caging single cells and particles”, Biosensors and Bioelectronics, vol. 14, pp. 247-256 (1999).
Non-Patent Document 6: B. H. Lapizco-Encinas, Blake A. Simmons, Eric B. Cummings, and Yolanda Fintschenko: “Insulator-based dielectrophoresis for the selective concentration and separation of live bacteria in water”, Electrophoresis, vol. 25, pp. 1695-1704 (June 2004).

### DISCLOSURE OF THE INVENTION

As pointed out above, microfluidic devices are required to show improved performances in order to meet the demand for more accurate analysis than ever, accommodating the diversification of the characteristics to be analyzed and reducing the quantity of specimen including reduction of dead volume, particularly in view of the problem that there is not any available technique of accurate analysis that does not physically and chemically damage specimens including biological materials. Additionally, there is not any available technique for automatically measuring the dielectric constant, the electric conductivity and other electric characteristics of a small specimen such as a micrometer-sized or nanometer-sized specimen in an on-line flow process.

Thus, it is the object of the present invention to make it possible to accurately analyze and/or sorting out a small quantity of specimens. In an embodiment of the present invention, the above object is achieved by using a flow channel having a structure where the edges of a plurality of electrodes, to which an alternating voltage is applied, surround a main flow channel in which specimens dispersed or floating in a carrier liquid flow with the carrier liquid.

### BRIEF DESCRIPTION OF THE DRAWINGS

FIG. 1 is a schematic plan view of the first embodiment of the present invention;

FIG. 2A is a schematic partial plan view, illustrating the operation of introducing specimens;

FIG. 2B is a schematic partial plan view, illustrating the operation of introducing specimens;

FIG. 2C is a schematic partial plan view, illustrating the operation of introducing specimens;

FIG. 3A is a schematic partial plan view, illustrating the gate effect and the condensation effect;

FIG. 3B is a schematic partial plan view, illustrating the gate effect and the condensation effect;

FIG. 3C is a schematic partial plan view, illustrating the gate effect and the condensation effect;

FIG. 4A is a schematic perspective view of the specimen introducing section;

FIG. 4B is a schematic perspective view of the specimen introducing section;

FIG. 5A is a schematic longitudinal cross sectional view, illustrating the configuration and the operation of the separating section;

FIG. 5B is a schematic longitudinal cross sectional view, illustrating the configuration and the operation of the separating section;

FIG. 5C is a schematic longitudinal cross sectional view, illustrating the configuration and the operation of the separating section;

FIG. 6A is a graph illustrating the principle of separation;

FIG. 6B is a graph illustrating the principle of separation;

FIG. 7 is a schematic illustration of the analyzing section and a peripheral apparatus;

FIG. 8 is a graph illustrating the arrival time spectrum obtained at the analyzing section;

FIG. 9 is a graph illustrating the frequency spectrum obtained at the analyzing section;

FIG. 10A is a schematic partial view, illustrating the sorting section;

FIG. 10B is a schematic partial view, illustrating the sorting section;

FIG. 10C is a schematic partial view, illustrating the sorting section;

FIG. 11 is a schematic illustration of the first embodiment of the present invention, showing the configuration of the entire apparatus;

FIG. 12 is a schematic illustration of an exemplar configuration of the alternating-current power supply 150 for dielectrophoresis of the first embodiment;

FIG. 13 is a schematic illustration of the relationship between the output of the alternating-current power supply 150 for dielectrophoresis of FIG. 12 and the alternating current applied to each electrode of the electrode group of the specimen introducing section;

FIG. 14 is a schematic illustration of an exemplar configuration of the entire apparatus according to the second embodiment of the present invention;

FIG. 15 is a schematic plan view according to the second embodiment of the present invention;

FIG. 16A is a schematic partial plan view, illustrating the operation of introducing specimens of the second embodiment;

FIG. 16B is a schematic partial plan view, illustrating the operation of introducing specimens of the second embodiment;

FIG. 16C is a schematic partial plan view, illustrating the operation of introducing specimens of the second embodiment;

FIG. 17 is a schematic perspective view of the separating section of the second embodiment;

FIG. 18A is a schematic partial transversal cross sectional view of the pillar-shaped obstacle region;

FIG. 18B is a schematic partial transversal cross sectional view of the pillar-shaped obstacle region;

FIG. 19A is a schematic contour map, illustrating the electric field gradient of the pillar-shaped obstacle region;

FIG. 19B is a schematic contour map, illustrating the electric field gradient of the pillar-shaped obstacle region;

FIG. 20A is a schematic partial perspective view, illustrating the gate effect and the condensation effect of the pillar-shaped obstacle region;

FIG. 20B is a schematic partial perspective view, illustrating the gate effect and the condensation effect of the pillar-shaped obstacle region;

FIG. 20C is a schematic partial perspective view, illustrating the gate effect and the condensation effect of the pillar-shaped obstacle region;

FIG. 21A is a schematic partial perspective view, illustrating the separation effect of the pillar-shaped obstacle region;

FIG. 21B is a schematic partial perspective view, illustrating the separation effect of the pillar-shaped obstacle region;

FIG. 21C is a schematic partial perspective view, illustrating the separation effect of the pillar-shaped obstacle region;

FIG. 22A is a graph illustrating the principle of separation of the pillar-shaped obstacle region;

FIG. 22B is a graph illustrating the principle of separation of the pillar-shaped obstacle region;

FIG. 23 is a schematic illustration of the analyzing section and a peripheral apparatus of the second embodiment;

FIG. 24A is a schematic partial view, illustrating the sorting section of the second embodiment;

FIG. 24B is a schematic partial view, illustrating the sorting section of the second embodiment;

FIG. 24C is a schematic partial view, illustrating the sorting section of the second embodiment;

FIG. 25A is a schematic cross sectional view of the pillar-shaped obstacle of another embodiment;

FIG. 25B is a schematic cross sectional view of the pillar-shaped obstacle of another embodiment;

FIG. 25C is a schematic cross sectional view of the pillar-shaped obstacle of another embodiment;

FIG. 25D is a schematic cross sectional view of the pillar-shaped obstacle of another embodiment; and

FIG. 25E is a schematic cross sectional view of the pillar-shaped obstacle of another embodiment.

### BEST MODE FOR CARRYING OUT THE INVENTION

Before describing specific embodiments of the present invention, the principle of the condensation effect, the gate effect and the separation effect of dielectrophoretic force will firstly be described below as it is indispensable for the description of the present invention.

According to Non-Patent Document 1, dielectrophoretic force (F) is generated when an electric field gradient exists in the fluid where particles (specific dielectric constant ε₂) are dispersed. It is attractive force (or repulsive force) that acts on the particles regardless of the polarity (the direction of lines of electric force) of the electric field and expressed by (formula 1) below.
F=2πr³ε₀ε₁·Rₑ[CM(ω)] grad |E|² (formula 1)

ε₀: dielectric constant of vacuum, d: particle diameter, E: electric field vector

From the (formula 1), it will be seen that the dielectrophoretic force (F) is proportional to the product of the three terms of the third power of the particle diameter r (or the volume of the particle), Rₑ[CM(ω)] which is the real number part of the Clausius Mossoty coefficient CM (ω)={(ε₂−ε₁)/(ε₂+2ε₁) } and the gradient of the second power of the electric field ∇|E|².

The specific dielectric constant ε₁ is about 80 when the fluid is water at temperature 25° C. and the specific dielectric constant ε₂ of an ordinary biological material is not greater than 10 so that negative dielectrophoretic force, or repulsive force, is applied from the electrodes on almost all the substances in water (in other words, F<0 because ε₂<<ε₁).

As dielectrophoretic force acts, a relative speed difference (v−u) as defined below is produced between the specimen (velocity v) that moves, floating in the carrier, and the carrier fluid (flowing velocity u).
6πηr(v−u)=2πr³ε₀ε₁·Rₑ[CM(ω)] grad |E|² (formula 2)

The relative speed difference is transformed into the difference of distance or time that depends on r₃ as will be described hereinafter so that the ingredients of the specimen are separated into bands that are arranged side by side (separation effect).

In other words, the specimen stays still in the flow of the carrier fluid at positions where the requirement of electric field gradient of
6πηrv−2πr³ε₀ε₁·Rₑ[CM(ω)] v |E|²=0 (formula 3)
is satisfied (gate effect). Additionally, Non-Patent Document 3, for instance, describes that, when negative dielectrophoretic force is made to act in a region surrounded by four electrodes on a plane or by eight electrodes in a space, specimen is confined to and trapped in the narrow space (condensation effect). The trapped specimen that is placed in the flow that satisfies the requirement of the (formula 3) is compressed in the flow direction and condensed further.

Generally, an alternating current with a frequency between about 100 Hz to about 100 MHz is used for the voltage to be applied to the electrodes for generating dielectrophoretic force. When an alternating voltage of the above frequency range is used, it is possible to cancel the electrophoretic force that acts when the particles are electrically charged by the time average effect. Additionally, it is possible to suppress the electrode reactions (electrolysis and so on) that arise when the electrodes are directly held in contact with fluid.

Now, the present invention will be described in greater detail by referring to the accompanying drawings that illustrate preferred embodiments of microfluidic device and apparatus according to the present invention.

### First Embodiment

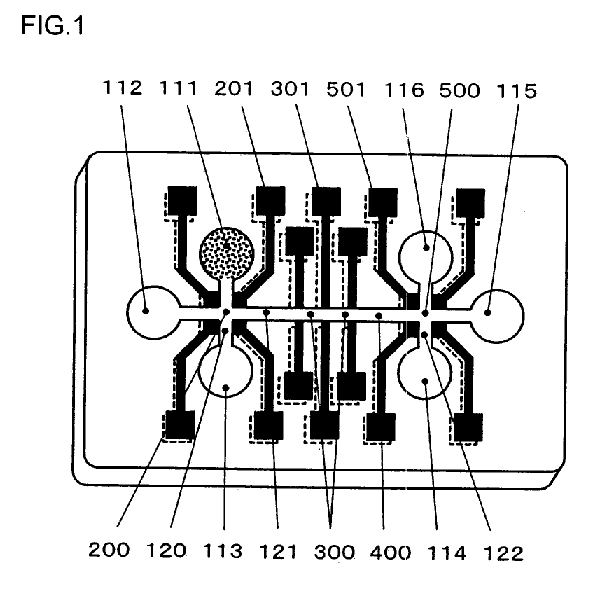

FIG. 1 is a schematic plan view of the first embodiment of microfluidic device for analyzing and sorting out applications according to the present invention. The configuration and the operation of the device will be described below. The microfluidic device comprises as main parts thereof a specimen introducing section 200, a separating section 300, an analyzing section 400, a sorting section 500 and their respective peripheral parts. The main flow channel 121 of the device is so arranged as to intersect the specimen flow channel 120 in the specimen introducing section 200 and the sorting flow channel 122 in the sorting section 500.

In the specimen introducing section 200, negative dielectrophoretic force is made to act on the specimen 101 cut out from the specimen flow channel 120 that intersects the main flow channel 121 so as to make the specimen concentrate in a narrow region located substantially at the center of the crossing flow channels, become condensed and stand by for the start of an analyzing process in a still state.

In the separating section 300, negative dielectrophoretic force is made to act on the specimen 101 that is concentrated substantially at the center of the main flow channel 121 as viewed in cross section so as to produce a retardation of the speed and a rearward positional shift according to size of specimen by means of the principle that will be described hereinafter.

The analyzing section 400 measures the delay time or the rearward positional shift of each of the specimen ingredients that is produced in the separating section 300 by means of an optical detection method. As a result of the measurement, the spectrum (chromatogram) of the existing amount of the ingredient relative to the delay time is obtained.

The sorting section 500 extracts only the necessary ingredient from the main flow channel according to the ingredient information or the predicted arrival time of the separated ingredient from the analyzing section 400.

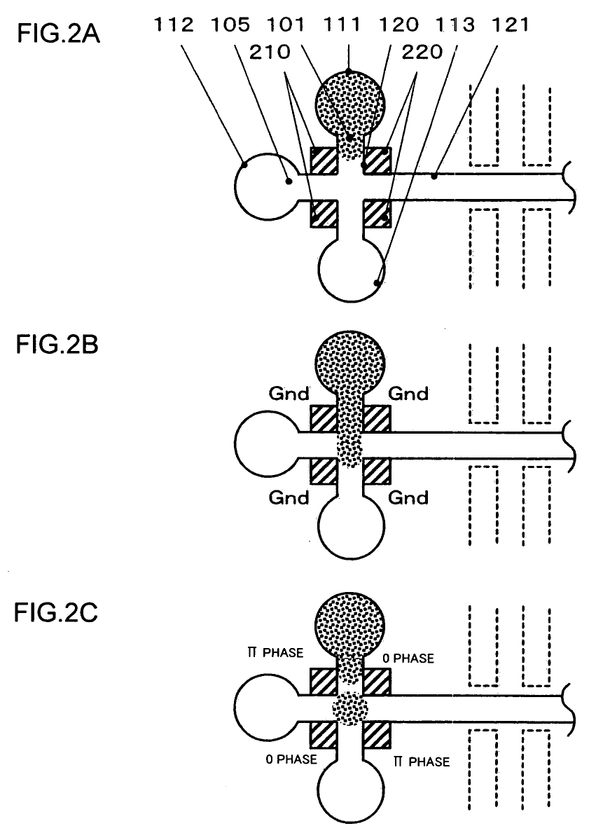

Now, the operation of the device until the specimen 101 is supplied to the specimen introducing section 200 will be described by referring to FIGS. 2A, 2B and 2C. As shown in FIG. 2A, the specimen 101 that contains blood ingredients such as erythrocytes, leucocytes and thrombocytes is driven to flow by the pressure from the specimen flow-in port 111 or the negative pressure (suction) from the waste liquid flow-out port 113 located downstream of the specimen flow channel 120, pushing out the carrier liquid filling the inside of the specimen flow channel 120, and become supplied. The operation of driving the specimen is stopped when the leading end of the specimen crosses the main flow channel 121 and blocks the intersection as shown in FIG. 2B.

Then, as an alternating voltage is supplied to the specimen introducing section electrode group 201 having a total of eight electrodes arranged in two layers including an upper layer and a lower layer, four being arranged respectively at the four corners of each layer, dielectrophoretic force acts on the specimen located at the crossing with the main flow channel and the specimen at the crossing of the intersecting flow channels is cut out from the specimen filling the specimen flow channel 120 as shown in FIG. 2C.

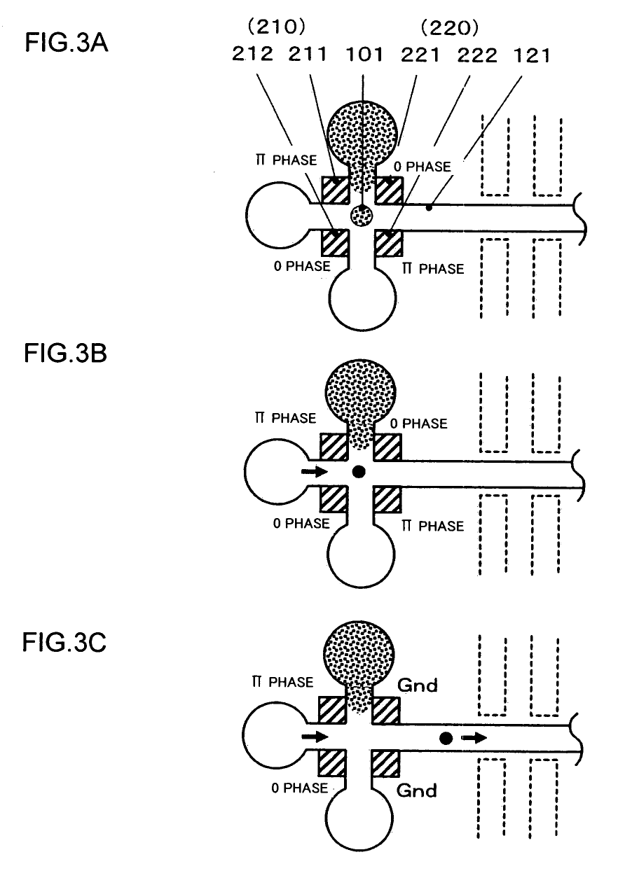

Now, the operation of the device until the specimen 101 is condensed in the specimen introducing section 200 and the separation process starts by referring to FIGS. 3A, 3B and 3C. The specimen 101 is subjected to strong repulsive force from the eight electrodes and confined to a narrow region at the center of the crossing so that it is condensed, while remaining still, as shown in FIG. 3A.

Then, pressure application from the carrier flow-in port 112 or suction from the waste liquid flow-out port 115 located at the most downstream end of the main flow channel 121 shown in FIG. 3A is started and the carrier fluid 105 starts flowing in the main flow channel 121. The specimen 101 is pushed toward the downstream side of the main flow channel by the viscose drag from the flow of the carrier but blocked by the repulsive force from the electrode group at the downstream side so that it is trapped in the crossing, compressed and further condensed as shown in FIG. 3B.

As the alternating voltage being applied to the downstream side electrode group 220 (or all the electrode groups 201 of the specimen introducing section) is turned off in this still state as shown in FIG. 3C, the repulsive force being acted on the specimen from the downstream side disappears and the specimen starts moving toward the downstream side, riding on the flow. At this timing, the separation process starts.

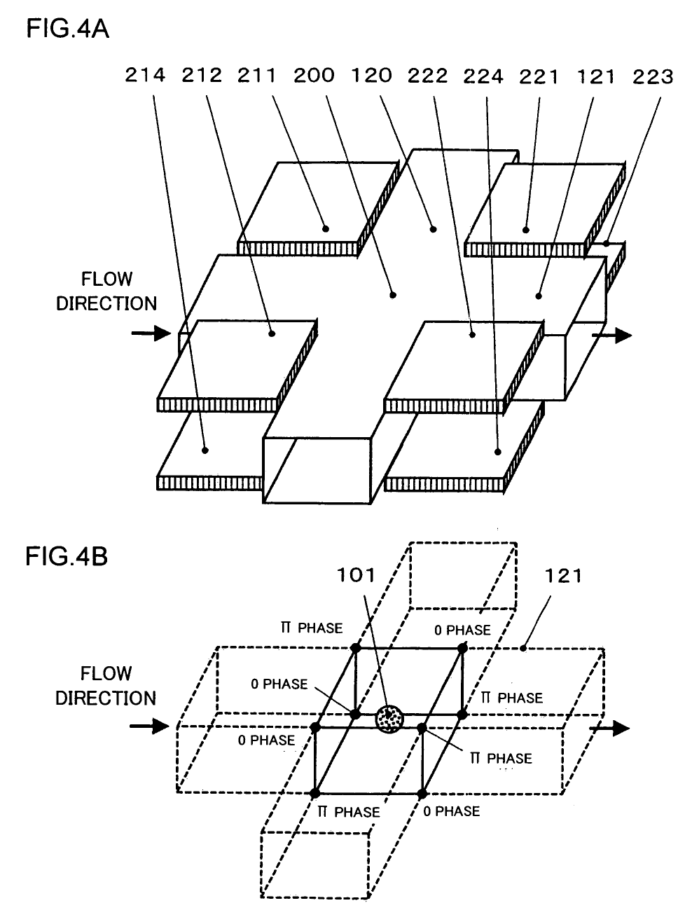

The phases of the alternating current that is applied to all the electrodes of the electrode groups 201 are illustrated in FIG. 4B that is a perspective view of the crossing flow channels. The phases of the alternating current are so set that the neighboring electrodes in the cross sectional direction show opposite phases (the extent of phase shift is 180° or π radians relative to each other) and the diagonally disposed electrodes show the same phase. Additionally, the neighboring electrodes of the upstream side electrode group and the downstream side electrodes group also show opposite phases. It is possible to generate a strong electric field and a large electric field gradient in a small region and cause a strong dielectrophoretic force to act by so setting the phase of the alternating current applied to the eight electrodes of the gate electrode groups that the neighboring electrodes show opposite phases.

The specimen 101 is confined to the narrow region and condensed in a still state so that velocity fluctuations and positional fluctuations in the flow direction and fluctuations of the accumulated thermal diffusion length are maximally removed. Due to these effects, this embodiment shows performances more excellent than any known methods of introducing a specimen from crossing flow channels.

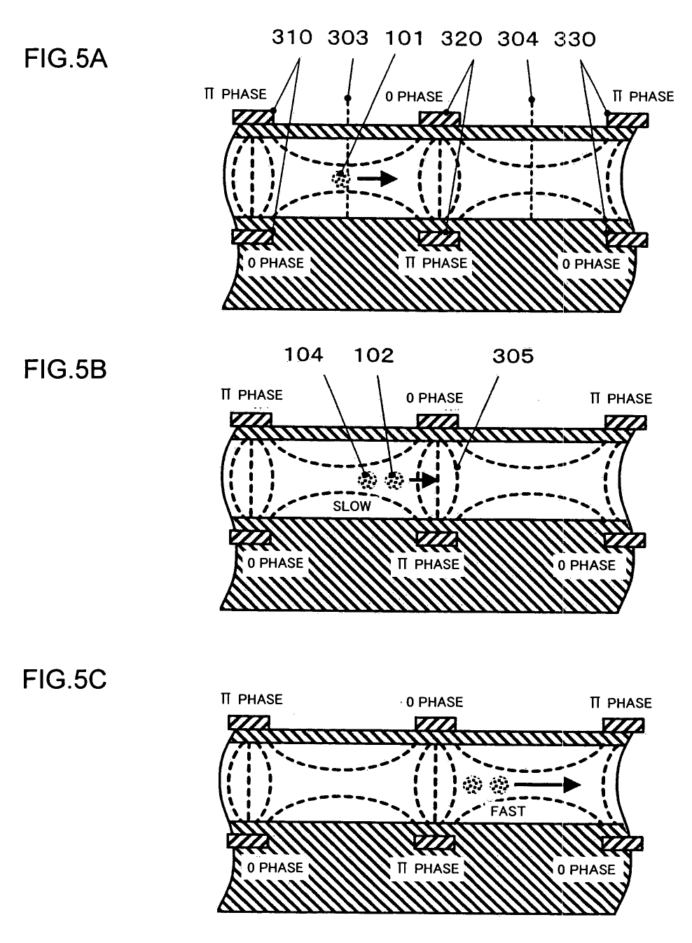

Now, the effects and the principle of the separation electrode groups 121 of the separating section 300 and the separated state of the specimen 101 will be described by referring to FIGS. 5A, 5B and 5C. FIG. 5A shows the positional relationship between the specimen 101 that flows into the separating section 300 in a state of being confined to a narrow region at the center of the flow and the separation electrode groups.

The operation of the separation electrodes for separating the ingredients of the specimen and the underlying principle will be described mainly in terms of the second stage separation electrode group 320. Assume here that all the ingredients are still moving in the same way all together until the specimen gets to the intermediate point 303 between the first stage separation electrode group 310 and the second stage separation electrode group 320 shown in FIG. 5A. The lines of electric force are parallel to each other at this intermediate point 303 and there is no gradient of the electric field so that specimen only receives the viscose drag from the fluid.

As the specimen moves into the downstream side beyond the intermediate point 303 as shown in FIG. 5B, the lines of electric force are densely arranged in the direction in which the specimen 101 proceeds and the moving speed of the specimen 101 is reduced by the negative dielectrophoretic force (repulsive force) applied by the second stage separation electrode group 320. As seen from the above (formula 1), the dielectrophoretic force is proportional to the third power of the particle diameter r, or the volume of the particle. Therefore, the relative speed that is the extent of shift from the velocity of the flow is reduced in proportion to the volume of each of the ingredient of the specimen so that the ingredients are separated from each other. This condition is continued until the specimen passes the second stage separation electrode group 320.

As shown in FIG. 5C, after passing the second stage separation electrode group 320, moving speed of the specimen is raised as it is pushed from behind by the negative dielectrophoretic force (repulsive force) applied by the second stage separation electrode group 320. Then, this condition is continued until the specimen passes the intermediate point 304 between the second stage separation electrode group 320 and the third stage separation electrode group 330.

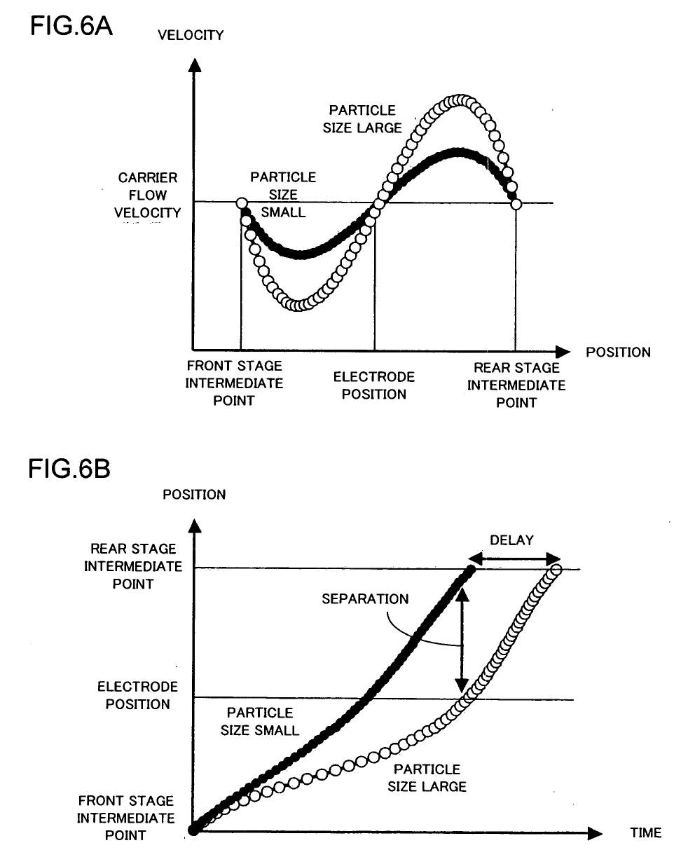

The ingredients of the specimen 101 that are separated from each other in this way are never reunited again. The reason for this will be described by referring to FIGS. 6A and 6B that show the result obtained on an assumption that the specimen consists of two particulate ingredients including large and small particulate ingredients whose radius ratio is 1.26 (or volume ratio is 2).

FIG. 6A shows the velocity difference between the specimen 101 and the carrier liquid shows a symmetrical relationship in the flow direction relative to an electrode. The specimen moves at a low speed between the upstream side intermediate point 303 and the second stage separation electrode group 320 but at a high speed between the second stage separation electrode group 320 and the downstream side intermediate point 304.

However, by paying attention to the times spent by the specimen to cross the respective two regions, it will be seen that the time spent by each of the ingredients of the specimen to pass the region from the upstream side intermediate point 303 to the second stage separation electrode group 320 is longer than the time spent by the specimen to pass the region from the second stage separation electrode group 320 to the downstream side intermediate point 304 and they show an asymmetric relationship. FIG. 6B shows a graph obtained by integrating the velocity in FIG. 6A from the upstream side intermediate point 303 to an arbitrarily selected position with time to show the relationship between time and the positions of the ingredients of the specimen.

From the graph, it will be seen that the ingredients of the specimen that are separated from each other never restore the original positional relationship. Additionally, the distance separating the ingredients of the specimen is increased each time they pass a separation electrode group so that the separation effect is improved by increasing the number of stages of separation electrodes.

The sensitivity of separation of the separating section 300 can be determined by changing the velocity of the flow under pressure and the alternating voltage. It is also possible to realize optimization of obtaining the highest sensitivity for each range of radius of particles to be observed. Additionally, it is possible to realize the highest efficiency for the separating section electrode groups 301 by setting the phases of the neighboring electrodes so as to be opposite to each other in order to maximize the potential difference between the electrodes as is the case with the electrode groups 201.

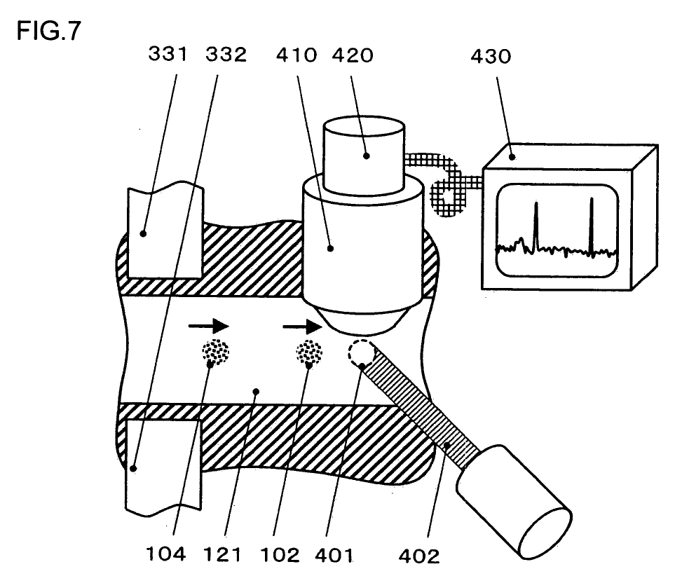

The ingredients of the specimen that are separated from each other by the separating section 300 moves on the flow under pressure of the carrier liquid 105 and data are obtained when they pass the analyzing section 400. FIG. 7 schematically illustrates the analyzing section 400 that is a component of this embodiment along with an external apparatus indispensable for the analysis. The configuration and operation will be described below.

After passing the separating section 300, the specimen flows toward point of observation 401, maintaining the positional relationship that the faster ingredient 102 of the specimen takes the lead and the slower ingredient 104 follows the former due to the velocity difference in the flow direction proportional to the difference of the third powers of the diameters (volumes).

As the ingredients of the specimen pass the point of observation 401, scattered light produced by irradiated light 402 is detected by means of a microscope 410 and an optical sensor 420. Since the detected scattered light reflects the very small quantity of the specimen and the projected cross section, it represents the quantity of the specimen existing at the point of observation that corresponds to the total volume or the density of the specimen. The detected data are transmitted to and accumulated in a data accumulation apparatus 430.

It is possible to know various properties of the specimen from the measured value of the arrival time. As described above for the basic formula (formula 1), dielectrophoretic force consists of three elements including a term that is proportional to the third power of the particle diameter r (or the volume of the particle), Rₑ[CM(ω)] which is the real number part of the Clausius Mossoty coefficient CM(ω) and the gradient of the second power of the electric field ∇|E|².

For the ingredients of a specimen having the same dielectric properties, the dielectrophoretic force applied thereto is proportional to r³of each of the gradient that corresponds to the volume thereof. The arrival time of an ingredient as detected by the detecting section reflects the strength of the force or the size of the ingredient of the specimen. Therefore, the particle size (or the volume) distribution of the ingredient of the specimen is obtained by observing the spectrum thereof.

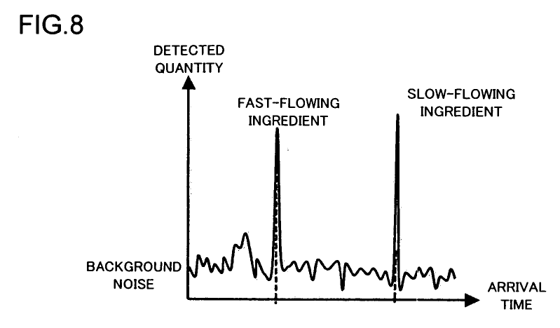

FIG. 8 is a graph illustrating the arrival time spectrum of a specimen containing two types of ingredients. More specifically, the graph is obtained by plotting the signals detected by the analyzing section 400 as the detected quantities of light relative to the time axis. The time axis, or the horizontal axis, of the graph indicates the time difference that corresponds to the ingredients of the specimen separated at the separating section 300 and shows one to one correspondence to the volume. The spatial density distribution or the spatial dispersion of the substance indicated by a detected quantity of light along the vertical axis corresponds to the existing quantity of each of the ingredients of the specimen.

Thus, the graph of FIG. 8 shows the existing quantity relative to the volume of each of the ingredients of the specimen. In this way, according to the present invention, it is possible to analyze a small quantity of a specimen with a high degree of accuracy and a high degree of sensitivity.

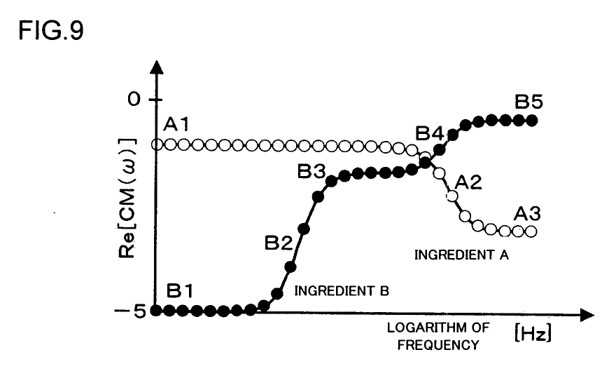

According to the present invention, it is also possible to estimate the electric constant, the electric conductivity and the approximate internal structure from the properties of the Clausius-Mossoty coefficient CM(ω) included in the basic formula of dielectrophoretic force by measuring the arrival time using frequency as parameter. FIG. 9 is a graph showing the real number part Rₑ[CM(ω)] of the Clausius-Mossoty coefficient CM(ω) as computed from the observed arrival time of the ingredients of a specimen containing two ingredients, using the frequency as variable.

From FIG. 9, it will be seen that the ingredient A of the specimen has a two-stage characteristic that has one transition and the ingredient B of the specimen has a three-stage characteristic that has two transitions. From the stages, it is estimated that the ingredient A of the specimen has an internal structure that can be considered to be homogeneous and the ingredient B of the specimen has an internal structure that is covered with a film.

If the dielectric constant and the electric conductivity of the carrier liquid are εₘ and σₘ respectively, the dielectric constant, the electric conductivity and the radius of ingredient A of the specimen are εₐ, σₐ, and Rₐ respectively, the dielectric constant, the electric conductivity and the radius of ingredient B of the specimen are ε_{b}, σ_{b} and R_{b} respectively and the electrostatic capacity and the conductance of the film part of the ingredient B of the specimen are C_{b} and G_{b} respectively, the following relationships are known from each of the characteristic points of the graph of FIG. 9.
Rₑ[CM(ω)] at point A1=(σₐ−σₘ)/(σₐ+2σₘ)
angular frequency (ω)) at point A2=(σₐ+2σₘ)/(εₐ+2Σₘ)
Rₑ[CM(ω)] at point A3=(εₐ−εₘ)/(εₐ+2εₘ)
Rₑ[CM(ω)] at point B1=(R_{b}G_{b}−σₘ)/(R_{b}G_{b}+2σₘ)
angular frequency (ω) at point B2=2σₘ/R_{b}C_{b}
Rₑ[CM(ω)] at point B3=(σ_{b}−σₘ)/(σ_{b}+2σₘ)
angular frequency (ω) at point B4=(σ_{b}+2σₘ)/(ε_{b}+2εₘ)
Rₑ[CM(ω)] at point B5=(ε_{b}−εₘ)/(ε_{b}+2εₘ)

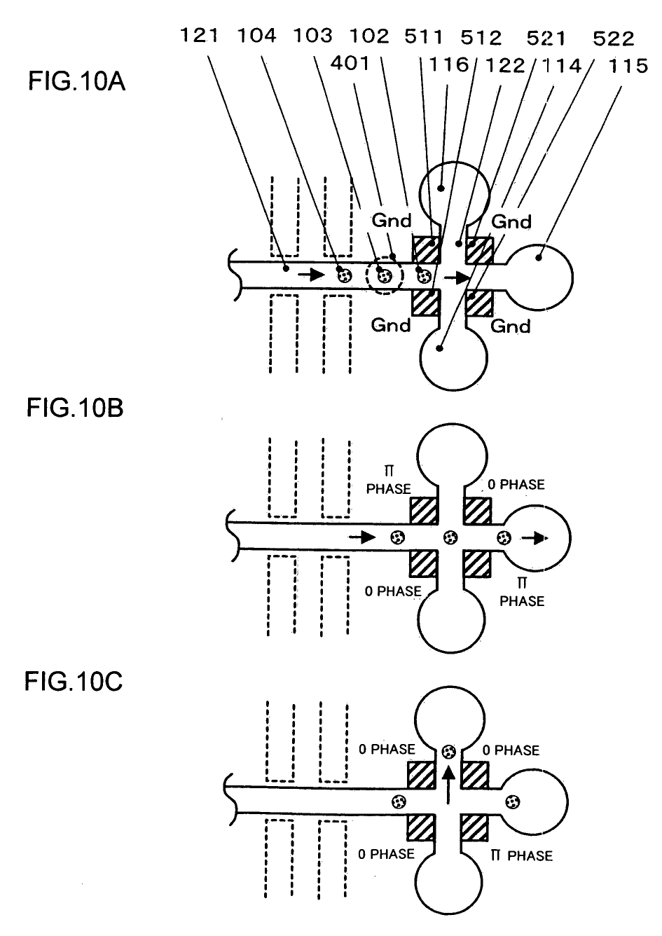

FIG. 10A shows how the separated ingredients of the specimen flow out from the separating section 300 and proceed toward the sorting section 500. The thrombocytes (5 to 50 cubic μm) expressed as the fastest leading ingredient 102, the erythrocytes (about 100 cubic μm) expressed as the intermediately fast ingredient 103 and the leucocytes (200 to 5,000 cubic μm) expressed as the slow ingredient of the specimen sequentially move to form a layered flow.

FIG. 10B shows the state when the erythrocytes that is the intermediate ingredient gets to the crossing region of the sorting section 500. As an alternating voltage is applied to sorting section electrode group 501 including eight electrodes such as electrode 511 in this state, the erythrocytes are trapped in the crossing of the crossing flow channels.

As shown in FIG. 10A, the phase relationship of the alternating current applied to the electrodes 511, 512, 521, 522 and the lower surface side electrodes 513, 514, 523, 524 (not shown) of the sorting section electrode group 501 is made asymmetric, the erythrocytes receive force in the direction of the sorting flow channel 122 and drawn out in the direction of the sorted specimen outlet port 116 (See FIG. 10C). In this way, according to the embodiment of the present invention, it is possible to sort out a small quantity of a specimen with a high degree of accuracy.

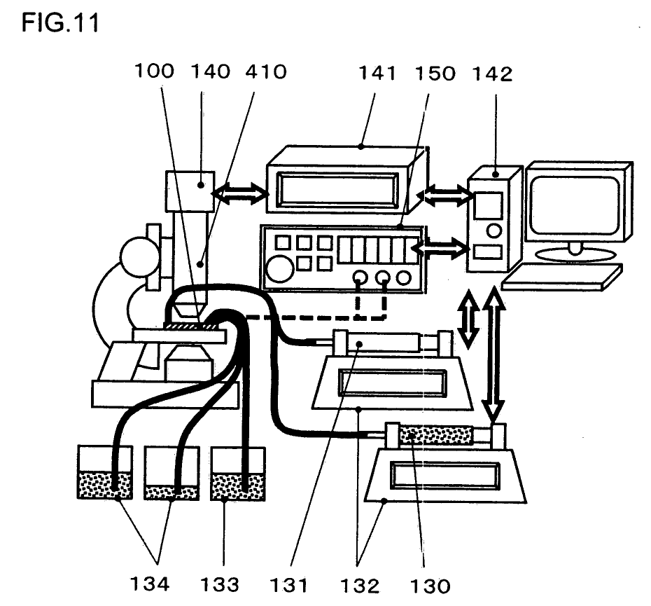

FIG. 11 is a schematic illustration according to the first embodiment of the present invention, showing the configuration of the entire apparatus. A specimen reservoir 130, a carrier liquid reservoir 131 and a liquid feed pump 132 for feeding out the specimen and carrier liquid are connected to the inlet port side of the flow channel of the microfluidic device 100. A waste liquid container 133 and a container for sorted specimen 134 for storing the sorted specimen are arranged at the outlet port side of the flow channel of the microfluidic device 100.

A microscope 410 that is a detection apparatus 140 is arranged so as to be focused at the observation point 401 of the microfluidic device 100 and a data collection/analysis apparatus 141 is connected to the detection apparatus 140, while a process control apparatus 142 is connected to the data collection/analysis apparatus 141 and an alternating current power supply 150 for dielectrophoresis is connected to the process control apparatus 142.

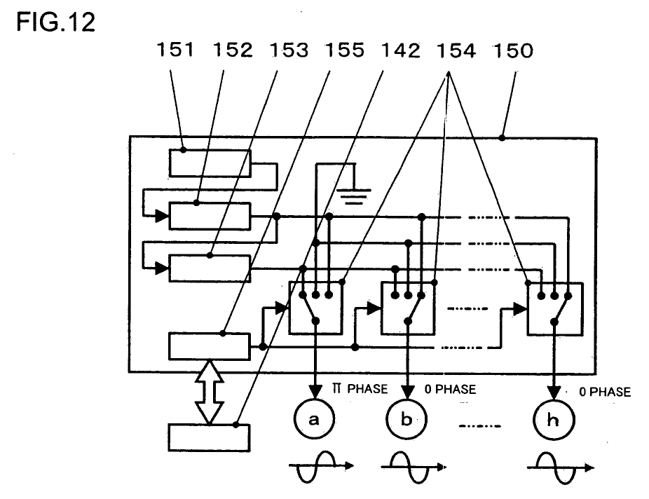

The alternating current power supply 150 for dielectrophoresis is typically formed in a manner as illustrated in FIG. 12. Referring to FIG. 12, the power supply comprises an oscillation circuit 151, an amplification circuit 152 for amplifying the oscillation output, a phase shift/amplification circuit 153 for shifting and amplifying the phase of the amplified output, selection circuits 154 connected to the respective electrodes of the electrode group 201 of the specimen introducing section and adapted to select any of the output of the phase shift/amplification circuit 153, the ground output and the output of the amplification circuit 152 and a decoder 155 for controlling the switching operation of the selection circuit 154.

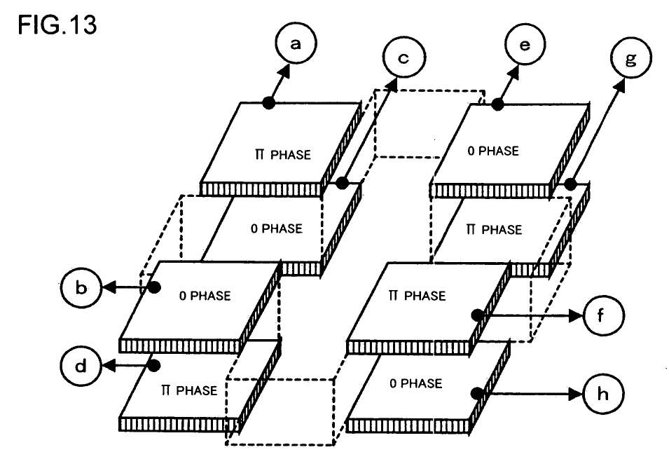

The output voltages (a) through (h) of selection circuits 154 are supplied to the respective electrodes of the electrode group 201 of the specimen introducing section as shown in FIG. 13.

Returning to FIG. 1, the carrier liquid reservoir 131 is connected to the carrier flow-in port 112 by way of a tube and carrier liquid is fed out by the liquid feed pump 132. Further, the specimen reservoir 130 is connected to the specimen flow-in port 111 by way of a tube and specimen is fed out by the liquid feed pump 132. The process that follows and the operation of each of the sections participating in the process are described above.

As the size of the specimen to be measured is reduced, the dielectrophoretic force is reduced in proportion to the third power of the radius r of the specimen as indicated by the (formula 1) so that it is normally difficult to separate and measure the ingredients of the specimen. Thus, it is desirable to use the second embodiment, which will be described below, for specimens with a size not greater than 200 nanometers.

### Second Embodiment

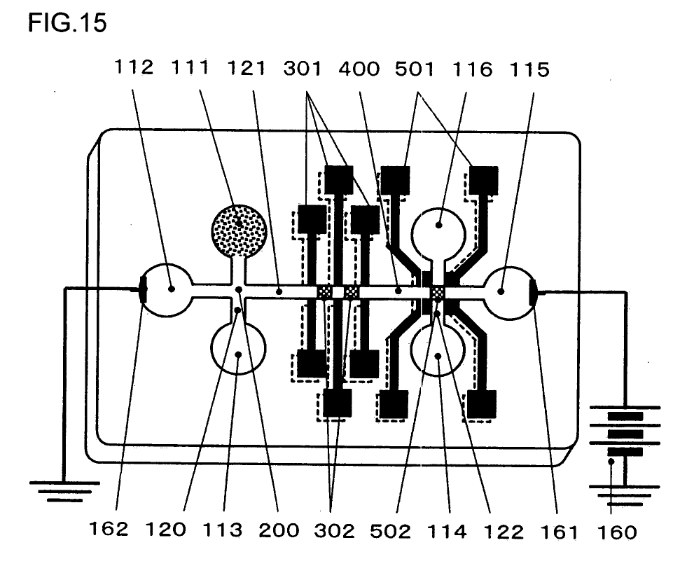

FIG. 15 is a schematic plan view of the second embodiment of microfluidic device for analyzing and sorting out applications according to the present invention. The configuration and the operation of the device will be described below.

The microfluidic device comprises as main parts thereof a separating section 300, an analyzing section 400, a specimen introducing section 200 arranged upstream, a sorting section 500 responsible for the last process and their respective peripheral parts. The configuration of this embodiment is substantially same as that of the first embodiment.

However, this embodiment differs from the first embodiment in that it is not pressure but an electrode for electrophoresis (to which a DC voltage is applied) to drive carrier liquid, that ordinary crossing flow channels that are free from any electrode are used in the specimen introducing section, that nanometer-sized pillar-shaped obstacles are arranged in the separating section 300 and the sorting section 500, that the gate effect and the condensation effect are realized not in the specimen introducing section 200 but in the sorting section 300 and that a thermal lens microscope is used as the specimen detecting means of the analyzing section 400. The following description of this embodiment is based on an assumption that the specimen is protein.

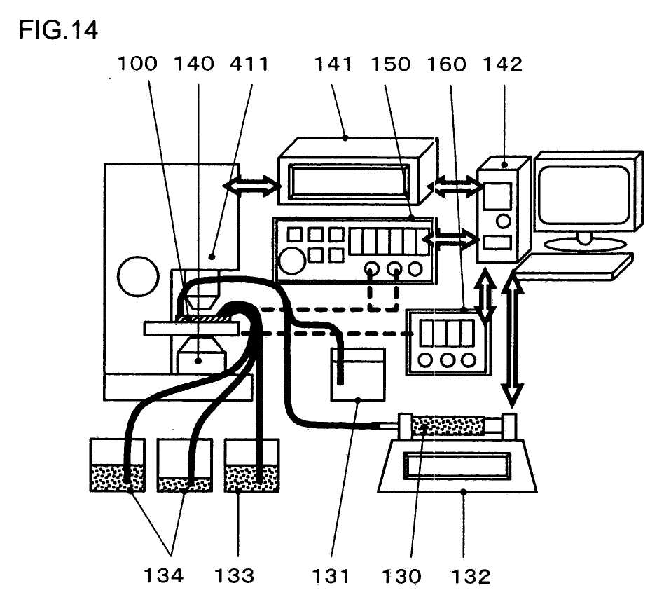

FIG. 14 is a schematic illustration according to the second embodiment of the present invention, showing the configuration of the entire apparatus. A specimen reservoir 130, a carrier liquid reservoir 131 and a liquid feed pump 132 for feeding out the specimen are connected to the inlet port side of the main flow channel of the microfluidic device 100.

A waste liquid container 133 and a container for sorted specimen 134 for storing the sorted specimen are arranged at the outlet port side of the flow channel of the microfluidic device 100.

A thermal lens microscope 411 that is a detection apparatus 140 is arranged so as to be focused at the observation point 401 of the microfluidic device 100 and a data collection/analysis apparatus 141 is connected to the photo-sensor 420 of the detection apparatus 140, while a process control apparatus 142 is connected to the data collection/analysis apparatus 141 and an alternating current power supply 150 for dielectrophoresis is connected to the process control apparatus 142. Additionally, a DC power supply 160 for driving the carrier liquid flowing through the main flow channel of the microfluidic device 100 by electrophoresis is connected to the process control apparatus 142.

Returning to FIG. 15, ordinary crossing flow channels (without any electrodes at the corners) are used in the specimen introducing section 200. The specimen 101 is driven under pressure to flow through the specimen flow channel 120 by a liquid feed pump and supplied to the specimen introducing section 200 where the specimen flow channel 120 crosses the main flow channel 121.

A positive electrode 161 is arranged at the waste liquid flow-out port 115 located at the most downstream end of the main flow channel, while a negative electrode 162 is arranged at the carrier flow-in port 112 located at the most upstream end of the main flow channel. The above-described DC power supply 160 is connected between the positive electrode and the negative electrode.

The specimen 101 supplied to the main flow channel 121 is applied with a DC voltage from the electrode and moved toward the separating section 300 by electrophoresis through the main flow channel 121.

Carrier liquid that is driven through the main flow channel 121 under the effect of electrophoresis and the specimen 101 that is cut out from the specimen flow channel 120 are supplied to the separating section 300. The specimen becomes still against the flow of carrier liquid (gate effect) and is made highly dense (condensation effect) and confined in the thin layer region in front of (at the upstream side of) a pillar-shaped obstacle region 302, where it stands by.

The separation process starts as the amplitude or the phase of the alternating voltage being applied to the eight electrodes of the first stage electrode group 310 and those of the second stage electrode group 320 that surround the separating section 300 is switched. As the gate is opened, the specimen 101 produces bands of the separated ingredients (separation effect) while it is passing in the inside of the pillar-shaped obstacle region 302. The principle of the condensation effect, the gate effect and the separation effect that are produced as a result of interaction of dielectrophoretic force and a flow will not be described here any further because they are already described above by referring to the first embodiment. Note, however, the effects become very strong in a small-sized region.

The analyzing section 400 measures the difference of the delay times or that of the extents of the positional shifts of the ingredients separated by the separating section 300 typically by means of a thermal lens microscope disclosed in the above-cited Patent Document 8 or 9. As a result of the measurement, a spectrum (chromatogram) of each of the existing quantities of the ingredients relative to the delay time is obtained.

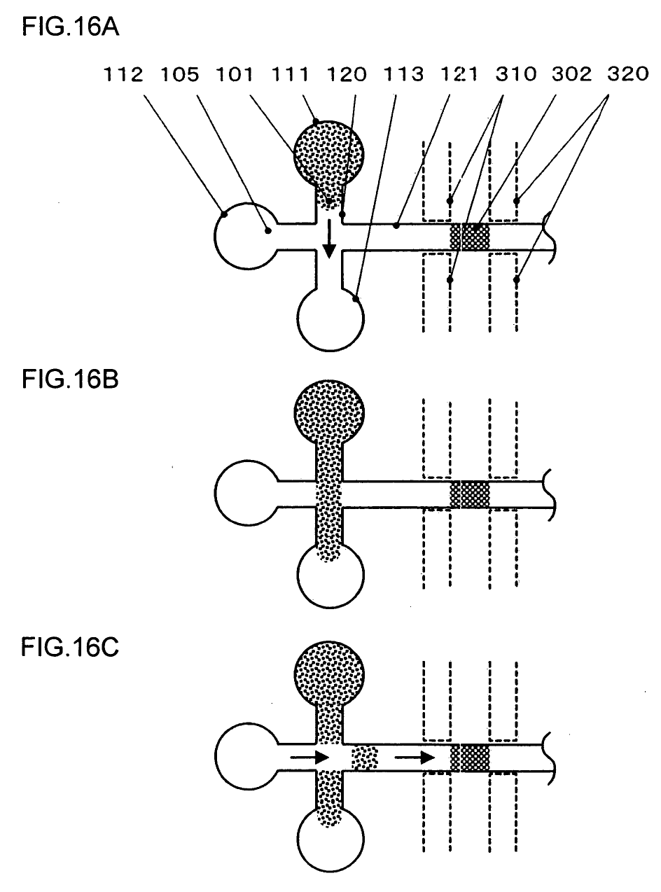

The operation of this embodiment until the specimen 101 is put into the main flow channel 121 will be described by referring to FIGS. 16A, 16B, 16C. As shown in FIG. 16A, the specimen 101 that contains protein is driven to flow by the pressure from the specimen flow-in port 111 or the negative pressure (suction) from the waste liquid flow-out port 113 located downstream of the specimen flow channel 120. The operation of driving the specimen is stopped when the leading end of the specimen crosses the main flow channel 121 and blocks the intersection as shown in FIG. 16B.

Then, a DC voltage is applied between the two electrodes (not shown) arranged in the inside of the carrier liquid flow-in port 112 and in the inside of the waste liquid flow-out port 113 located at a downstream position of the main flow channel 121 to start driving carrier liquid 105 by dielectrophoretic force.

As carrier liquid 105 starts flowing in the inside of the main flow channel 121, the specimen found in the crossing of the main flow channel 121 and the specimen flow channel 120 starts moving toward the separating section 300 by the quantity corresponding to the width of the specimen flow channel 120.

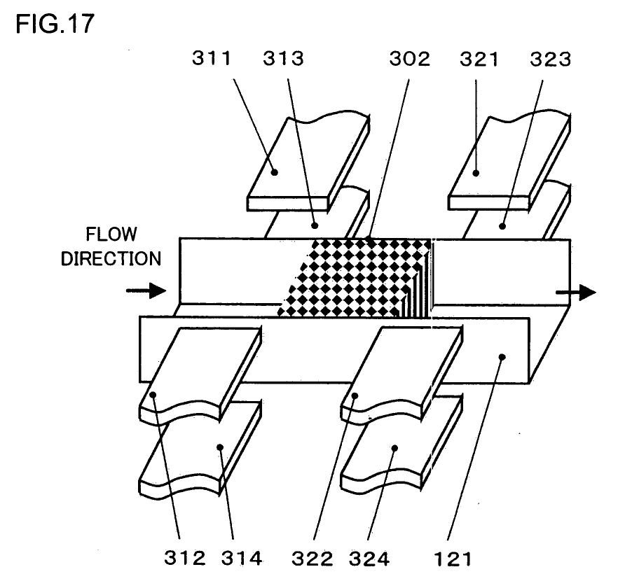

As shown in FIG. 17, the separating section 300 comprises as minimal units thereof the pillar-shaped obstacle region 302 arranged in the main flow channel 121 and the eight electrodes of the first stage separation electrode group 310 (electrodes 311, 312, 313, 314) and the second stage separation electrode group 320 (electrodes 321, 322, 323, 324) enclosing the pillar-shaped obstacle region 302. In this embodiment, another pillar-shaped obstacle region (not shown) is arranged between the second stage separation electrode group 320 and the third stage separation electrode group 330, these realize a 2-stage separation process.

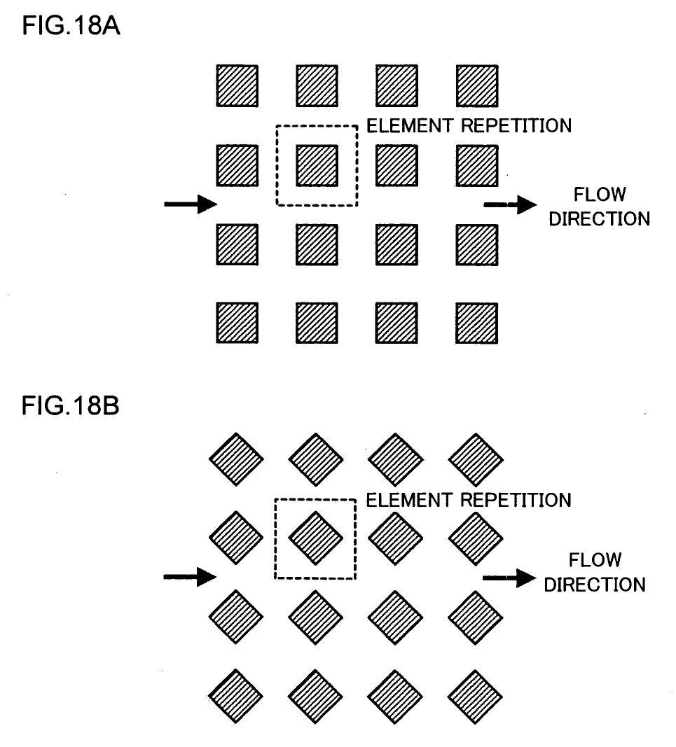

A large number of nanometer-sized pillars are arranged at a constant pitch with regular intervals in the pillar-shaped obstacle region 302. In the instance of this embodiment, the pillar-shaped obstacles show a profile of a quadrangular prism and are arranged to form a square grid-like pattern at a pitch of twice of a side thereof as shown in FIG. 18A in cross section. Therefore, the space occupancy ratio of the pillar-shaped obstacles is about 25% in the region 302.

FIG. 18A illustrates a structure where quadrangular-prism-shaped obstacles showing a square cross section are aligned. FIG. 18B shows the same quadrangular-prism-shaped obstacles turned by 45°.

The separating section 300 operates for switching from the exertion of the gate effect and the condensation effect that proceeds simultaneously with the gate effect in the former half of the process time of a series of processes to that of the separation effect in the latter half of the process time. The switching operation is performed by controlling the amplitude, the phase or the frequency of the alternating voltage applied to the electrodes of the first stage separation electrode group 310 and the second stage separation electrode group 320.

As seen from the (formula 1), dielectrophoretic force has a term that is proportional to r³ and hence is rapidly reduced as the size of the particles of the specimen. For example, when a specimen of protein (with a particle size from about 1 mm to tens of several nanometers) in a hollow micro flow channel as described above by referring to the first embodiment is handled, the dielectrophoretic force is overpowered by the molecules diffusing force (Brownian motion) and it is practically impossible to realize the gate effect, the condensation effect and the separation effect.

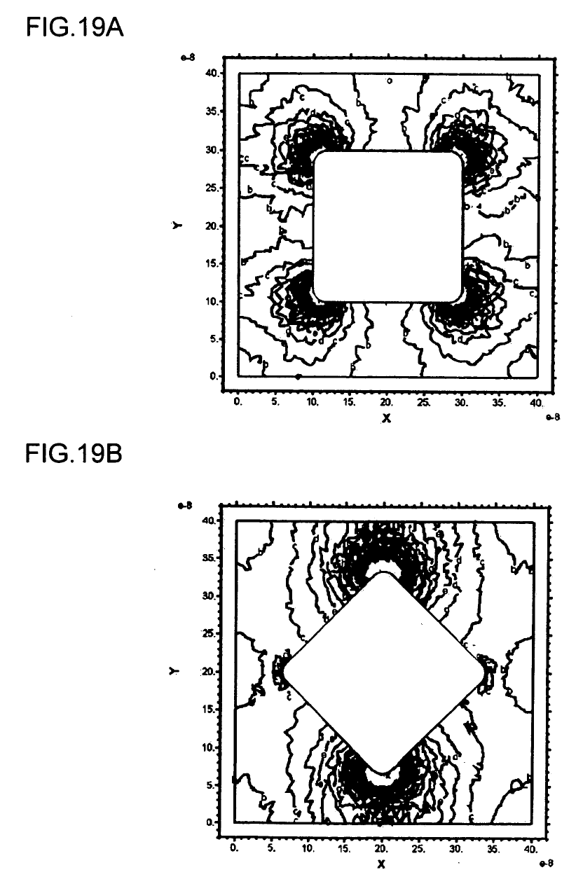

On the other hand, when pillar-shaped obstacles of two types of quadrangular prism elements as illustrated in FIG. 18A or 18B are arranged in the flow channel, a considerably different scene appears. FIGS. 19A and 19B are schematic illustrations of the electric fields obtained by simulation when a voltage of 0.4 V/400 nm is applied in the horizontal direction in the drawing to the respective regions where quadrangular prisms having 200 nm long sides are arranged at a pitch of 400 nm and correspond respectively to FIGS. 18A and 18B. The factor of ∇|E|² that is a component of dielectrophoretic force is shown as contour lines. The dielectrophoretic force that is applied to the specimen is about 1,000 times of the dielectrophoretic force that is obtained when a hollow micro flow channel is used so that it is found that the dielectrophoretic force effectively acts on a specimen with a particle size of several nanometers. This embodiment is based on this finding.

The gate effect, the condensation effect and the separation effect of the present invention will be described further below on an assumption that pillar-shaped obstacles as shown in FIG. 18B are arranged.

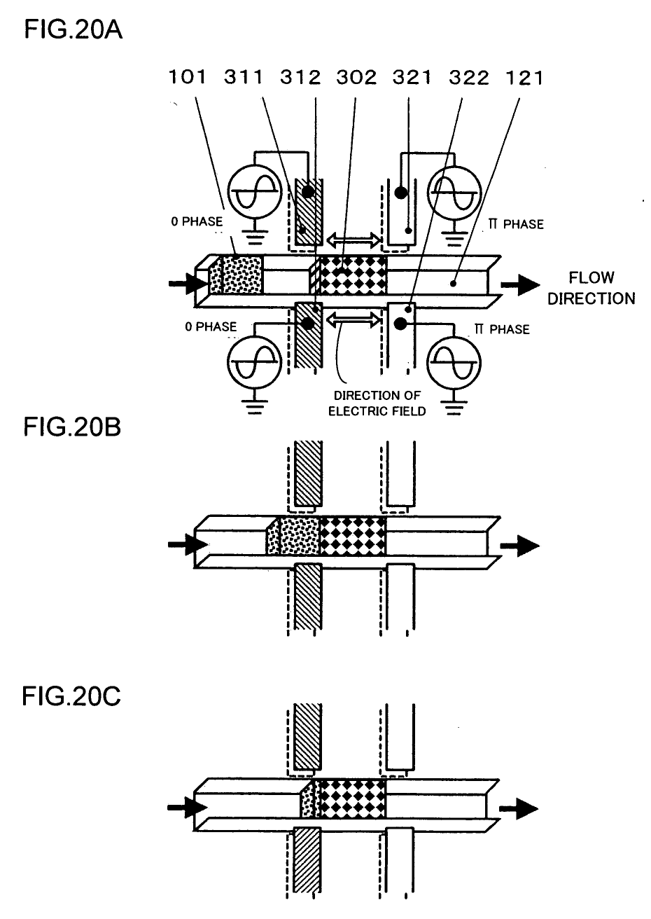

As shown in FIG. 20A, the specimen 101 put into the main flow channel 121 subsequently flows from the upstream side in a thinly dispersed state until it gets to the measurement starting position. As an alternating voltage is applied to the electrodes of the first stage separation electrode group 310 with the normal phase (0 phase) and to the electrodes of the second stage separation electrode group 320 with the opposite phase (with a phase difference of π radian or 180°), a steep electric field gradient region is generated to bridge the pillar-shaped obstacles in the direction perpendicular to the direction of the flow in the inside of the pillar-shaped obstacle region 302 as shown in FIG. 19B.

As the leading end of the specimen 101 gets to the corresponding end of the pillar-shaped obstacle region 302 as shown in FIG. 20B, the specimen is subjected to strong repulsive force (negative dielectrophoretic force) due to the steep electric field gradient and hence cannot get into the pillar-shaped obstacle region 302. Therefore, the specimen 101 comes to a standstill in front of the pillar-shaped obstacle region 302 (gate effect). Since carrier liquid 105 is not subjected to any dielectrophoretic force, it passes through the pillar-shaped obstacle region 302.

Thus, all the input specimen is carried on the flow of carrier liquid 105 to continuously gets to the separating section 300 and become standing still as shown in FIG. 20C. At the same time, the two forces including the viscose drag from the carrier liquid 105 and the repulsive force from the pillar-shaped obstacles act in opposite directions and compress the specimen 101 to confine the specimen 101 in a thin region in front of the pillar-shaped obstacle region 302 and condense it (condensation effect).

Now, the method of releasing the specimen from the gate effect will be described below. To allow the condensed specimen 101 standing by in a state of being blocked by the front surface of the pillar-shaped obstacle region 302 to pass in the inside of the pillar-shaped obstacle region 302, it is only necessary to reduce the amplitude of the applied alternating voltage. As an example, a method of changing the phase of the alternating voltage by utilizing the effect specific to dielectrophoretic force will be described blow for the purpose of reducing the amplitude of the applied voltage in this embodiment.

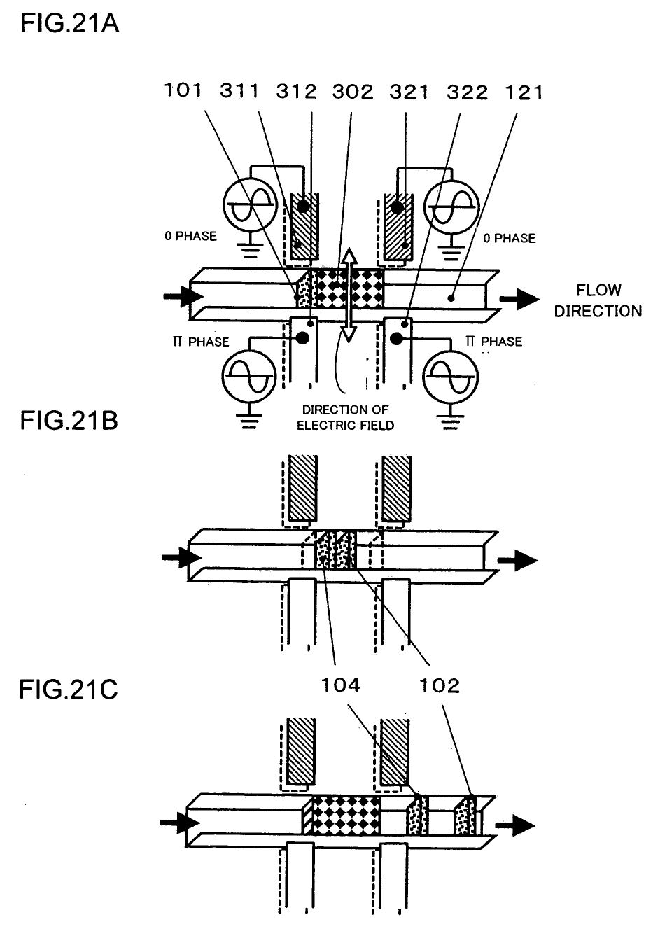

FIG. 21A shows the scene at the moment when the specimen is released from the gate effect and a measuring operation is started. By paying attention to the phase of the alternating voltage being applied to the electrodes of the electrode groups, it will be seen that the phase of the upper right electrode 312 and that of the lower right electrode 314 of the first stage that used to be phase 0 before the opening of the gate are switched to phase π and the phase of the upper left electrode 321 and that of the lower left electrode 323 of the second stage that used to be phase π before the opening of the gate are switched to phase 0.

Accordingly, the steep electric field gradient region, that used to bridge the pillar-shaped obstacles and fill the gaps thereof in the direction of transversally crossing the flow channel before the opening of the gate, is changed to bridge the pillar-shaped obstacles and fill the gaps thereof in the direction perpendicular to the above direction. As a result, the specimen can proceed through the pillar-shaped obstacle region 302. In other words, the gate is opened. At this timing, the timing operation for measuring the arrival time of the specimen at the downstream side is started.

FIG. 21B shows the scene that appears at the time when the specimen 101 starts flowing into the pillar-shaped obstacle region 302 to a small extent so that the ingredients start to be separated from each other. FIG. 21C shows the scene that appears when the fast moving ingredient 102 and the slow moving ingredient 104 of the specimen are separated from each other from the pillar-shaped obstacle region 302. According to the present invention, the ingredients of a specimen can be separated from each other accurately by a short distance in a short period of time. The band-shaped ingredients of the specimen separated by way of the above described process are directed toward the next detecting section with carrier liquid.

As described earlier by referring to the first embodiment, the separation takes place in a situation where the inclination of the electric field of the flow channel through which the specimen and carrier liquid flow is not even but uneven and repeatedly changed from steep to mild and vice versa at a constant pitch. In other words, the requirement that they move at a low speed on an upslope of the electric field gradient and at a high speed on a downslope of the electric field gradient and that the time during which the specimen is found on the upslope is longer than the time during which the specimen is found on the downslope needs to be met.

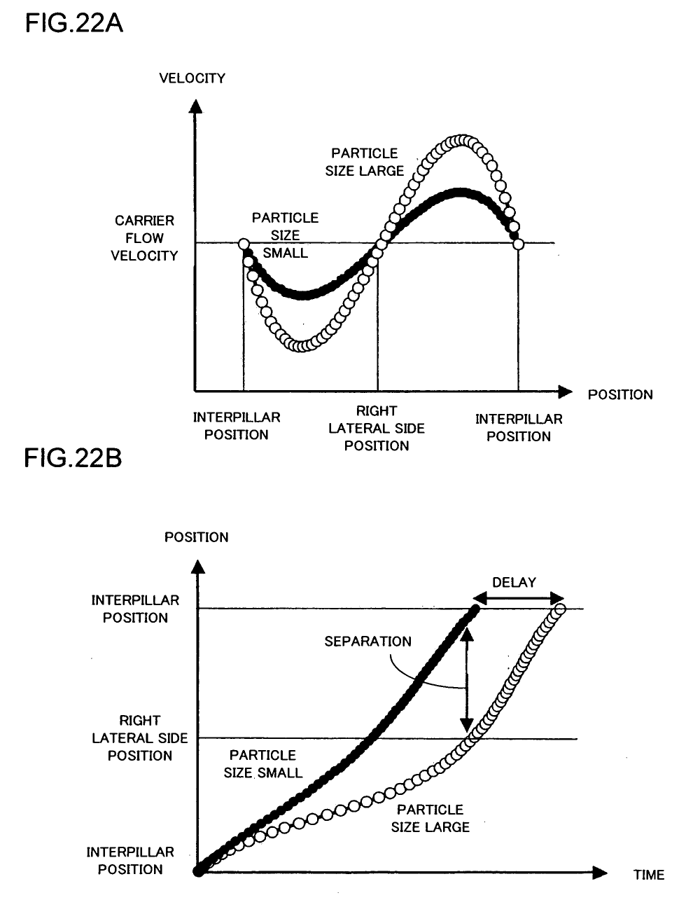

This will be described briefly below by referring to FIGS. 22A and 22B. Assume here that the specimen contains two ingredients whose dielectric constants and the electric conductivities are equal to each other and that differ from each other only in terms of particle size (radius ratio: 1:1.26, volume ratio: 1:2) and is made pass through an upslope region and a downslope region that are considerably steep.

FIG. 22A is a graph of the velocities of the two ingredients of the specimen relative to the position within the span of a single pillar-shaped obstacle. FIG. 22A is equivalent to FIG. 6A when the expression of the electrode position and the intermediate point is replaced by that of the right lateral side position of the pillar and the inter-pillar position.

FIG. 22B is a graph illustrating the characteristics of the relationship between time and position. FIG. 22B shows that the arrival time for the specimen to pass through the span of a single pillar-shaped obstacle is short for the ingredient having a smaller particle size of the specimen so that the ingredient having a smaller particle size of the specimen moves far, or gets to a far position, in a given time period. In other words, the two ingredients of the specimen are separated from each other. In actuality, the difference of arrival time is a value that is specific not only to the sizes of the ingredients of the specimen but also to the other characteristics including the profile and the complex dielectric constant.

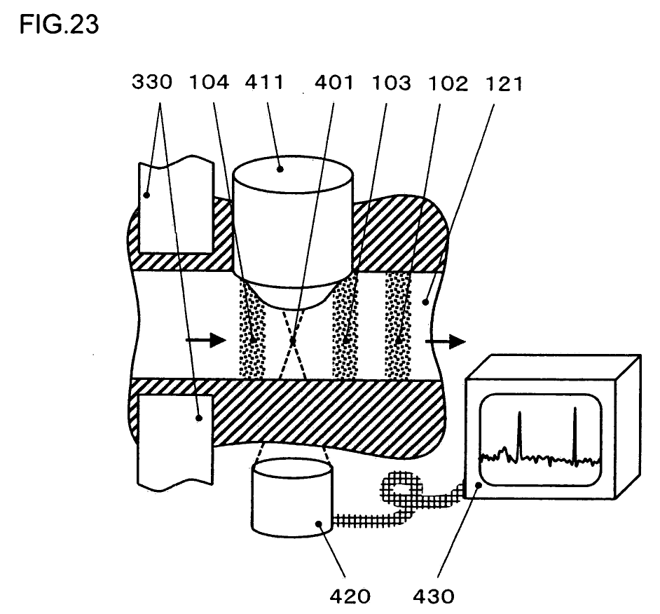

The ingredients of the specimen that are separated at the separating section 300 move on the flow of carrier liquid 105 and data on them are obtained as they pass through the analyzing section 400. FIG. 23 shows the analyzing section 400 along with a schematic illustration of the external apparatus required for analysis. Their configurations and effects will be described below.

After passing through the separating section 300, the fast-moving ingredient 102, the intermediately fast-moving ingredient 103 and the slow-moving ingredient 104 form respective band structures in the mentioned order due to the positional shifts that are produced due to the difference of the third powers of their radii r (or their volumes) and flow toward the point of observation 401.

The ingredients of the specimen that pass through the point of observation 401 are detected by the thermal-lens microscope 411 and data on the number of micro particles and the dispersion densities of the ingredients of the specimen are obtained from the outputs of the sensor 420. Additionally, the period of time for each of the ingredients to get to the point of observation 401 from the time when the gate is opened is also obtained. The detected data are sent to and accumulated in data accumulating apparatus 430.

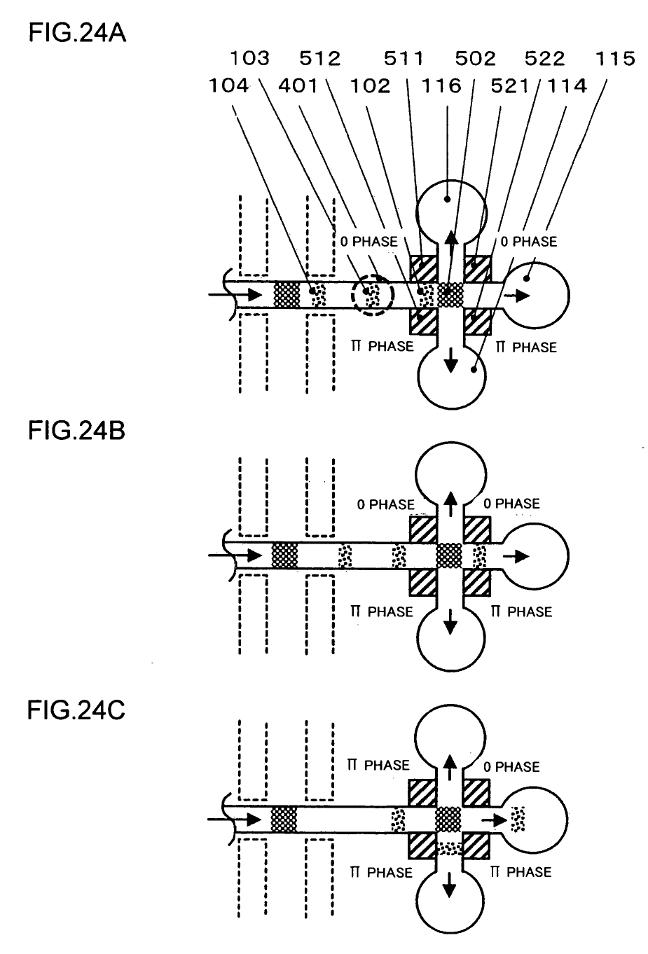

After the acquisition of the data on the ingredients of the specimen by the analyzing section 400 and after the substance is identified or estimated, the specimen is sorted by the sorting section 500 according to the data. FIGS. 24A, 24B, 24C are schematic plan views of the sorting section, schematically illustrating the operation thereof. FIG. 24A is a scene where the fast-moving ingredients 102 has already passed the point of observation 401 and the intermediately fast-moving ingredient 103 is passing the point of observation 401 while the slow-moving ingredient 104 is moving toward the point of observation 401.

FIG. 24B is a scene where the target to be sorted out is found to be the intermediately fast-moving ingredient 103 from the outcome of the analysis made by the analyzing section 400 and the sorting section is waiting for the ingredient 103 of the specimen getting to it. As the target ingredient gets to the crossing region of the pillar-shaped obstacles surrounded by the electrodes of the electrode groups, the phases or the amplitudes of the voltage being applied to the electrode groups are so controlled as to realize a combination that switches the moving route of the ingredient from the main flow channel 121 to the sorting flow channel 122. Then, only the intermediately fast-moving ingredient 103 of the specimen moves toward the sorted specimen outlet port 114 and becomes sorted out as shown in FIG. 24C.

### Examples of Modifications to the Above-described Embodiments

While the direction of the electric field of the applied alternating current is switched in the above-described second embodiment as an example of technique for exerting the gage effect on the specimen at the separating section 300, it is possible to use some other technique for the purpose of the present invention. For instance, a technique of controlling the voltage value of the applied alternating electric current may alternatively be used. With such a technique of controlling and changing the applied voltage, it is possible to use the device as a filter for allowing a specimen to pass through it when the specimen is found within a specific size range. Additionally, it is possible to flow the ingredients of a specimen preliminarily separated to a certain extent, by flowing the specimen with gradually decreasing the voltage as time series.

While two types of alternating voltage showing a phase different of π radian (180°) are used in the above-described embodiments, a technique of controlling the alternating voltage difference (potential difference) of the voltage being applied between the electrodes by controlling the phase difference may alternatively be used for the purpose of the present invention.

A technique of controlling the frequency of the alternating voltage may alternatively be used. If such is the case, it is possible to observe or estimate the complex dielectric constant and the particle structure of the specimen from the obtained frequency responsive data and the characteristics of the Clausius-Mossoty coefficient that is a function of the frequency.

While an alternating current is applied to the electrodes of the electrode groups 201 of the specimen introducing section in the above-description of the second embodiment, a similar alternating current may also be applied to the other electrode groups.

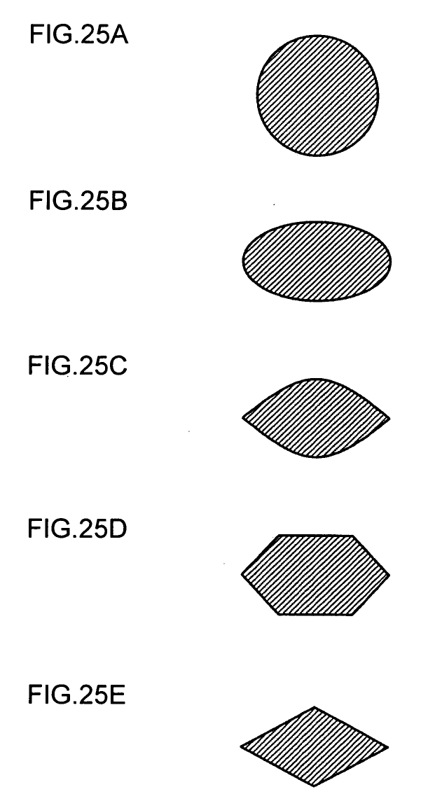

While the pillar-shaped obstacles of the separating section are quadrangular prisms showing a square cross section in the above-description of the second embodiment, pillar-shaped obstacles showing a circular, elliptic, spindle-shaped, flat hexagonal or rhombic cross section as shown in FIGS. 25A, 25B, 25C, 25D and 25E may alternatively be used.

The profile of the pillars can be designed appropriately so as to meet the objective. For example, pillars showing a spindle-shaped cross section are advantageous for the purpose of separation. Pillar-shaped obstacles may not necessarily be repetition of the same profile and size and may alternatively be repetition of two different profiles. The combination of two or more than two different profiles can be optimized because it is possible to obtain a characteristic pattern specific to the separation effect by selecting a combination.

While there are three stages of separation electrode groups in the first embodiment, there are three stages of electrode groups 301 and two stages of pillar-shaped obstacle regions 302 in the second embodiment. However, the present invention is by no means limited to these embodiments in terms of the number of stages. In other words, there is not limitation to the number of stages of separation electrode groups and the number of pillar-shaped obstacle regions. For example, two stages of separation electrode groups and a single pillar-shaped obstacle region may be provided. However, the separation performance is improved when both the number of stages and the number of separation electrode groups are increased and the accuracy of separation is improved when the separating section 300 is made long.

The gate effect that appears in the specimen introducing section 200 of the first embodiment and in the separating section 300 of the second embodiment is described above as a binary effect of allowing the specimen to pass or blocking it.

However, to be more rigorous about the gate effect of the present invention, it is an effect of blocking a substance of which (the third power of) the radius r of the particles that is a term of the (formula 1) is greater than a threshold value. The threshold value is a function of the angular frequency ω (which is a variable of the complex dielectric constant) of the (formula 1) and the gradient ∇|E|² of the electric field. Thus, the gate effect indicated in the above-described embodiments is a concept including a filter effect that operates for the size and the complex dielectric constant of the specimen. In other words, a microfluidic device according to the present invention may be used as a filter whose definition and modification can electrically controlled and can be used as a simple separation and analysis device by using only the gate effect thereof.

Crossing flow channels having electrodes are used in the specimen introducing section and the sorting section of the first embodiment and crossing flow channels having electrodes and pillar-shaped obstacles are used in the sorting section of the second embodiment.

However, the present invention is not limited to the use of such crossing flow channels and there is no need of providing limitations for combining simple crossing flow channels as disclosed in Patent Document 7 and crossing flow channels having electrodes and/or crossing flow channels having pillar-shaped obstacles proposed by this invention in the specimen introducing section or the sorting section.

The specimen introducing section may have a Y-shaped flow channel having two flow-in routes, one of which is used for introducing a specimen and the other of which is used for introducing carrier liquid or a Ψ-shaped flow channel having three flow-in route, the central one of which is used for introducing a specimen and the other two of which sandwiching the central one are used for introducing carrier liquid. However, the arrangement described above by referring to the embodiments can improve the ease of handling and reliability (of eliminating introduction of unnecessary ingredients).

Only a combination of the 0 phase and the π phase (180°) is shown for the phase relationship of the alternating voltage applied to each of the electrode groups in the first embodiment and the second embodiment. However, the present invention is by no means limited to such a combination and the combination in each of the embodiments is not limited to the described one. While a similar operation can be realized by holding the electrode of the π phase (180°) to the ground potential or all the electrodes to the same phase, the former combination reduces the dielectrophoretic force and the latter combination further reduces the dielectrophoretic force. However, such combinations can simplify the wiring arrangement of the drive circuit and the device.

While carrier liquid is assumed to be water in the first and second embodiments, it is not necessary to limit carrier liquid to water for the purpose of the present invention. In other words, any liquid showing a dielectric constant that is higher than those of ordinary solid substances (showing a specific dielectric constant not higher than 10 at most) may be used for the purpose of the present invention. For example, ethylene glycol, ethanol, methanol and acetone show a specific dielectric constant at least not lower than 20 and can be subjected to negative dielectrophoretic force (repulsive force from electrodes) relative to ordinary biological materials so that such liquid substances can be used for the purpose of the present invention. Note, however, that benzene, toluene, kerosene and gasoline can give rise to positive dielectrophoretic force (attractive force to electrodes) and may have difficulties for use. It is also difficult to use ferroelectric solid substance.

Four electrodes are provided around a flow channel in the first and second embodiments. However, the number of electrodes is by no means limited to four and a single and continuous ring-shaped electrode or electrodes other than four may be used. However, computations on electric fields show that the electrodes are preferably arranged near the wall of the flow channel for producing a relatively strong electric field gradient getting to the center of the flow channel and the use of four to eight electrodes is preferable from the viewpoint of efficiency.

While the specimen to be handled is assumed to be spherical particles in the first embodiment and the second embodiment, the present invention can handle a specimen that is not spherical particles. For example, string-shaped particles of a substance such as DNA as disclosed in Non-Patent Document 2 may be assumed to be ellipsoids of revolution, the width being the minor axis, the length being the major axis for applying the present invention.

The profile and the positions of the electrodes of the specimen introducing section electrode group 201, those of the separating section electrode group 310, 320, those of the sorting section electrode group 501 are substantially symmetrical between the upstream side and the downstream side in the above-description of the first embodiment and the second embodiment. However, the profile of electrodes is not limited to a symmetrical shape and asymmetrical electrodes may alternatively be arranged for the purpose of the present invention. For example, the electrodes may be made narrow in an accelerating region and wide in a decelerating region to separate ingredients efficiently in a short period of time.

The mechanism of moving the specimen in a microchannel for the purpose of the present invention is described above in terms of a pressurized flow in the first embodiment and electrophoresis in the second embodiment. However, pressure, electrophoresis, electroosmosis (to be globally classified as electrophoresis) or a combination of any of them may be used to drive liquid for the purpose for the present invention. Furthermore, any other means may be used for the purpose of the present invention. In other words, there are no limitations for the type of flow so long as it can achieve the objective of the use.

It should be noted that a technique using a pressurized flow that is free from electric stimulus is preferable for a specimen containing living objects with a size of more than micrometers such as cells, bacteria and blood corpuscles for which a hollow flow channel is used as described above by referring to the first embodiment.

On the other hand, it is preferable to use a technique involving electrophoresis or electroosmosis that can realize a uniform flow (plugged flow) required for separation (chromatogram) of stripe-shaped objects with a size of not more than 200 nanometers such as viruses, protein and DNA for which a flow channel having a pillar-shaped obstacle structure is used as described above by referring to the second embodiment.

While a blood specimen and a protein specimen are used above to describe the first embodiment and the second embodiment respectively, specimens that can be used are not limited to living substances such as blood and protein.

According to the present invention, it is possible to accurately separate a target object without using a label such as a fluorescent substance. Hence, it is possible to sort out the target object in a natural condition to measure the size of the target object and analyze it without damaging it. For example, leucocytes and thrombocytes can be handled in the state where the viscosity thereof is not activated and they are not deformed, and a protein can be handled in the state where no conformational change occurs.

Additionally, it is possible to make the specimen floating or dispersed and suspended in carrier liquid to stand still, stand by (gate effect) and become condensed, while allowing carrier liquid to flow. The gate effect leads to a specimen saving effect of not wasting the input specimen and can reduce the quantity of the specimen and dissolve the current dead volume problem.

It is also possible to accurately define the starting position and the starting time of a separation process and the specimen disperses little during the separation process so that the arrival time can be measured highly accurately. Particularly, it is possible to realize an accurate measuring operation for relatively large molecules (e.g., larger than 1 M Daltons) that conventional chromatography cannot measure.

Similarly, it is possible to determine the dielectric constant and the electric conductivity of a minute ingredient of a specimen and estimate the structure and profile thereof, if they are simple, by means of a measuring technique using the frequency of an alternating current as parameter.

The first embodiment of the invention is adapted to handle the specimen at a central part of the flow of carrier liquid and the second embodiment of the invention is adapted to cause a strong repulsive force to act on the specimen from an obstacle structure. Thus, according to the invention, it is possible to provide a microfluidic device and an analyzing apparatus where the specimen hardly adheres to the wall surface of the flow channel and the obstacle structure so that the device and the apparatus can be cleaned and maintained well with ease and are practically free from contamination.

A microfluidic device according to the present invention can be used not only for analyzing and sorting out an ingredient of a specimen but also for simply analyzing or sorting out an ingredient of a specimen.

Thus, as described above in detail, a microfluidic device and an analyzing/sorting apparatus according to the present invention can suitably be used for analyzing and sorting out an ingredient of a small quantity of specimen with high accuracy.

1. A microfluidic device having a main flow channel for allowing a fluid including carrier liquid and a specimen to flow and analyzing or sorting out the specimen, comprising:
a plurality of electrodes arranged around a part of the main flow channel and adapted to apply an alternating voltage in order to cause dielectrophoretic force to act on the specimen passing through it.

2. The device according to claim 1, wherein
the plurality of electrodes is arranged at an intersection where the main flow channel intersects another flow channel and includes a total of eight electrodes, four arranged at the corners of the upper surface of the main flow channel and four arranged at the corners of the lower surface of the main flow channel at the intersection.

3. The device according to claim 2, further comprising:
a pillar-shaped obstacle arranged in the main flow channel and having a plurality of pillar-shaped bodies arranged in a single direction orthogonal relative to both the direction of the main flow channel and the direction of the other flow channel intersecting the main flow channel.

4. The device according to claim 3, wherein
the carrier liquid and the specimen are forced to flow through the main flow channel by the DC voltage applied between the electrodes arranged at the leading end and the trailing end of the main flow channel.

5. A specimen analyzing/sorting apparatus adapted to use a microfluidic device according to claim 4 and analyze or sort out the specimen by measuring the velocity difference or the arrival time getting to a specific position in the flow channel produced by an electrodynamic action or an electro-hydrodynamic action on the size or the electric property of the specimen.

6. The microfluidic device according to claim 2, wherein
the carrier fluid and the specimen are forced to flow through the main flow channel by the voltage difference of the voltage applied between the leading end and the trailing end of the main flow channel.

7. A specimen analyzing/sorting apparatus adapted to use a microfluidic device according to claim 6 and analyze or sort out the specimen by measuring the velocity difference or the arrival time getting to a specific position in the flow channel produced by an electrodynamic action or an electro-hydrodynamic action on the size or the electric property of the specimen.

8. A microfluidic device having a main flow channel for allowing a fluid including carrier liquid and a specimen to flow and analyzing the specimen, comprising:
a carrier flow-in port that receives the carrier liquid;
a specimen flow channel arranged at the inlet port side of the main flow channel and adapted to add the specimen to the carrier liquid received from the carrier flow-in port;
a separating electrode group including a plurality of electrodes to be subjected to a voltage applied thereto and arranged around a part of the main flow channel in order to separate the specimen by exerting the action of dielectrophoretic force on it when the specimen added from the specimen flow channel passes the main flow channel; and
an analyzing section that analyzes the specimen by optically detecting the specimen passing through the main flow channel.

9. The device according to claim 8, wherein
a plurality of separating electrode groups is arranged at a plurality of positions of the main flow channel, each group including four electrodes arranged at the upper and lower left and right corners of a cross section of the main flow channel and adapted to be subjected to at least to two voltages of different kinds including a first alternating voltage and a second alternating voltage having a phase and an amplitude value different from those of the first voltage.

10. The device according to claim 9, further comprising:
a pillar-shaped obstacle arranged at a position between the positions where the separating electrode groups are arranged and having a plurality of pillar-shaped bodies arranged in a single direction orthogonal to the flow.

11. The device according to claim 10, wherein
the carrier liquid and the specimen are forced to flow through the main flow channel by the DC voltage applied between the electrodes arranged at the leading end and the trailing end of the main flow channel.

12. A specimen analyzing/sorting apparatus adapted to use a microfluidic device according to claim 11 and analyze or sort out the specimen by measuring the velocity difference or the arrival time getting to a specific position in the flow channel produced by the action of dielectrophoretic force on the size or the electric property of the specimen.

13. The microfluidic device according to claim 9, wherein
the carrier fluid and the specimen are forced to flow through the main flow channel by the voltage difference of the voltage applied between the leading end and the trailing end of the main flow channel.

14. A specimen analyzing/sorting apparatus adapted to use a microfluidic device according to claim 13 and analyze or sort out the specimen by measuring the velocity difference or the arrival time getting to a specific position in the flow channel produced by the action of dielectrophoretic force on the size or the electric property of the specimen.

15. A microfluidic device having a main flow channel for allowing a fluid including carrier liquid and a specimen to flow and sorting out the specimen, comprising:
a carrier flow-in port that receives the carrier liquid;
a specimen flow channel arranged at the inlet port side of the main flow channel and adapted to add the specimen to the carrier liquid received from the carrier flow-in port;
a separating electrode group including a plurality of electrodes to be subjected to an alternating voltage applied thereto and arranged around a part of the main flow channel in order to separate the specimen by exerting the action of dielectrophoretic force on it when the specimen added from the specimen flow channel passes the main flow channel; and
a sorting channel arranged at the outlet side of the main flow channel to sort out the specimen.

16. The device according to claim 15, wherein
a plurality of separating electrode groups is arranged at a plurality of positions of the main flow channel, each group including four electrodes arranged at the upper and lower left and right corners of a cross section of the main flow channel and adapted to be subjected to at least to two voltages of different kinds including a first alternating voltage and a second alternating voltage having a phase and an amplitude value different from those of the first voltage.

17. The device according to claim 16, further comprising:
a pillar-shaped obstacle arranged at a position between the positions where the separating electrode groups are arranged and having a plurality of pillar-shaped bodies arranged in a single direction orthogonal to the flow.

18. The device according to claim 17, wherein
the carrier liquid and the specimen are forced to flow through the main flow channel by the DC voltage applied between the electrodes arranged at the leading end and the trailing end of the main flow channel.

19. The device according to claim 17, wherein
the pillar-shaped bodies have a quadrangular cross section.

20. The device according to claim 16, wherein
the carrier fluid and the specimen are forced to flow through the main flow channel by the voltage difference of the voltage applied between the leading end and the trailing end of the main flow channel.
